(19) United States
(12) Patent Application Publication
(10) Pub. No.: US 2018/0309210 A1
(43) Pub. Date: Oct. 25, 2018

(54) ARRAY ANTENNA

(71) Applicant: Murata Manufacturing Co., Ltd., Kyoto (JP)

(72) Inventor: Kaoru SUDO, Kyoto (JP)

(21) Appl. No.: 15/959,604

(22) Filed: Apr. 23, 2018

(30) Foreign Application Priority Data
Apr. 24, 2017 (JP) 2017-085531

(51) Int. Cl. H01Q 21/06; H01Q 3/24; H01Q 3/34; H01Q 9/04

(52) U.S. Cl. CPC H01Q 21/06; H01Q 9/04; H01Q 3/34; H01Q 3/24

(57) ABSTRACT

Provided is an array antenna in which a plurality of sub-arrays, which each include a plurality of radiating elements, are two-dimensionally arranged in a first direction and a second direction, which are perpendicular to each other. A plurality of power feeding lines individually feed power from a high-frequency input/output device to each of the plurality of sub-arrays. The plurality of sub-arrays are arranged along straight lines in the first direction, and are arranged in the second direction such that among two sub-arrays that are adjacent to each other in the second direction, one sub-array is shifted in the first direction with respect to the other sub-array.

This application claims priority from Japanese Patent Application No. 2017-085531 filed on Apr. 24, 2017. The content of this application is incorporated herein by reference in its entirety.

### BACKGROUND OF THE DISCLOSURE

### 1. Field of the Disclosure

The present disclosure relates to an array antenna.

### 2. Description of the Related Art

Array antennas are disclosed in International Publication No. 2010/089941 and Japanese Unexamined Patent Application Publication (Translation of PCT Application) No. 2010-541315. The array antenna disclosed in International Publication No. 2010/089941 includes first antenna elements that are arranged at a prescribed element interval and second antenna elements that are arranged at the same element interval so as to be parallel to the arrangement direction of the first antenna elements. Power is supplied to the first antenna elements via lines that branch at a first branching point, and power is supplied to the second antenna elements via lines that branch at a second branching point. The second branching point is shifted a prescribed distance in the arrangement direction with respect to the first branching point. Unwanted radiation from the array antenna is reduced by arranging the positions of the branching points of the power feeding lines at the desired positions.

The array antenna disclosed in Japanese Unexamined Patent Application Publication (Translation of PCT Application) No. 2010-541315 includes at least four one-dimensional radiator arrays. The even-numbered radiator arrays are shifted by ½ the inter-radiator distance with respect to the odd-numbered radiator arrays. The density of the radiators can be optimized and consequently beam formation is improved by shifting the radiator arrays.

A signal output from one oscillator is branched to a plurality of radiating elements of a one-dimensional radiator array, and then the resulting signals are phase shifted by phase-shift push-push oscillators. The signals, which have been phase shifted in a direction in which the radiators of the one-dimensional radiator array are arranged (array direction), are branched in a direction in which the four one-dimensional radiator arrays are arranged next to each other (direction perpendicular to array direction), and then a prescribed phase difference is applied to each signal and the resulting signals are supplied to the respective radiators.

In the array antenna disclosed in International Publication No. 2010/089941, a signal that is branched at a branching point of a power feeding line is supplied to individual antenna elements. Therefore, the array antenna cannot be made to operate as an active phased array antenna.

In the array antenna disclosed in Japanese Unexamined Patent Application Publication (Translation of PCT Application) No. 2010-541315, beam steering can be performed in the array direction by changing a phase shift amount using the phase-shift push-push oscillators. Although the desired coverage can be provided in the direction perpendicular to the array direction by applying a prescribed phase difference, beam steering cannot be performed in this direction. In addition, when the number of radiating elements is increased in order to obtain high antenna gain, the number of targets that are to be subjected to phase shift control is increased and the high-frequency circuit becomes more complex.

### BRIEF SUMMARY OF THE DISCLOSURE

An object of the present disclosure is to provide an array antenna that can perform beam steering in both an azimuth direction and an elevation direction, can suppress an increase in the number of targets to be subjected to phase shift control, and that can obtain high antenna gain.

An array antenna according to a first preferred embodiment of the present disclosure includes: a plurality of sub-arrays that each include a plurality of radiating elements and are two-dimensionally arranged in a first direction and a second direction, which are perpendicular to each other; and a plurality of power feeding lines that individually feed power from a high-frequency input/output device to the plurality of sub-arrays. The plurality of sub-arrays are arranged along straight lines in the first direction, and are arranged in the second direction such that among two sub-arrays that are adjacent to each other in the second direction, one sub-array is shifted in the first direction with respect to the other sub-array.

A high-frequency signal can be supplied to the plurality of sub-arrays via the power feeding lines while applying a desired phase difference. Thus, beam steering can be performed with respect to the first direction and the second direction. Since the plurality of sub-arrays are arranged in the second direction so as to be shifted with respect to each other in the first direction, the effective pitch of the sub-arrays with respect to the first direction as a whole is smaller than the pitch of the sub-arrays of one row arranged in the first direction. As a result, the beam swing angle with respect to the first direction can be made large. One input/output terminal of the high-frequency input/output device is connected to a plurality of radiating elements included in one sub-array, and therefore a greater number of radiating elements can be arranged than the number of input/output terminals. Due to the number of radiating elements being increased, a high antenna gain can be obtained. In other words, even though the number of radiating elements is increased, an increase in the number of input/output terminals of the high-frequency input/output device can be suppressed.

An array antenna according to a second preferred embodiment of the present disclosure has the configuration of the array antenna according to the first preferred embodiment and is further characterized in that the plurality of sub-arrays are arranged at a first pitch in the first direction, and a shift amount with respect to the first direction between positions of two sub-arrays that are adjacent to each other in the second direction is less than or equal to ½ the first pitch.

The effective pitch of the plurality of sub-arrays with respect to the first direction can be made smaller than the first pitch.

An array antenna according to a third preferred embodiment of the present disclosure has the configuration of the array antenna according to the second preferred embodiment and is further characterized in that a plurality of images obtained by orthogonally projecting the plurality of sub-arrays in straight lines parallel to the first direction are arranged at a regular pitch less than or equal to ½ the first pitch in the first direction.

The array antenna can operate as an active phased array antenna in which the sub-arrays are arranged at a regular pitch that is less than or equal to ½ the first pitch with respect to the first direction.

An array antenna according to a fourth preferred embodiment of the present disclosure has the configuration of the array antenna according to any one of the first to third preferred embodiments and is further characterized in that the plurality of sub-arrays arranged in the second direction are arranged in a zig-zag pattern.

When the plurality of sub-arrays that are arranged in the second direction are arranged in a zig-zag pattern, the width of the zig-zag pattern corresponds to the shift amount of the sub-arrays in the first direction.

An array antenna according to a fifth preferred embodiment of the present disclosure has the configuration of the array antenna according to any one of the first to fourth preferred embodiments and is further characterized in that the plurality of sub-arrays are arranged at a second pitch in the second direction.

The array antenna can operate as an active phased array antenna in which the sub-arrays are arranged at the second pitch with respect to the second direction.

An array antenna according to a sixth preferred embodiment of the present disclosure has the configuration of the array antenna according to any one of the first to fifth preferred embodiments and is further characterized in that the plurality of sub-arrays each consist of 2ⁿ of the radiating elements, where n is a positive integer.

Power can be fed to the radiating elements by repeatedly branching the power feeding line into two branches in each sub-array.

Other features, elements, characteristics and advantages of the present disclosure will become more apparent from the following detailed description of preferred embodiments of the present disclosure with reference to the attached drawing.

### BRIEF DESCRIPTION OF THE SEVERAL VIEWS OF THE DRAWINGS

FIG. 1A is a plan view of array antenna according to a first embodiment and FIG. 1B is a diagram illustrating a connection state between the array antenna and a high-frequency input/output device;

FIG. 2A is a plan view illustrating one sub-array and a part of a power feeding line, and FIG. 2B is a sectional view of a part of the array antenna;

FIG. 3 is a plan view illustrating one sub-array and a part of a power feeding line of an array antenna according to a second embodiment;

FIG. 4A is a plan view of one sub-array of an array antenna according to a third embodiment, and FIGS. 4B and 4C are plan views of one sub-array of an array antenna according to modifications of the third embodiment; and

FIG. 5 is a plan view of an array antenna according to a fourth embodiment.

### DETAILED DESCRIPTION OF THE DISCLOSURE

### First Embodiment

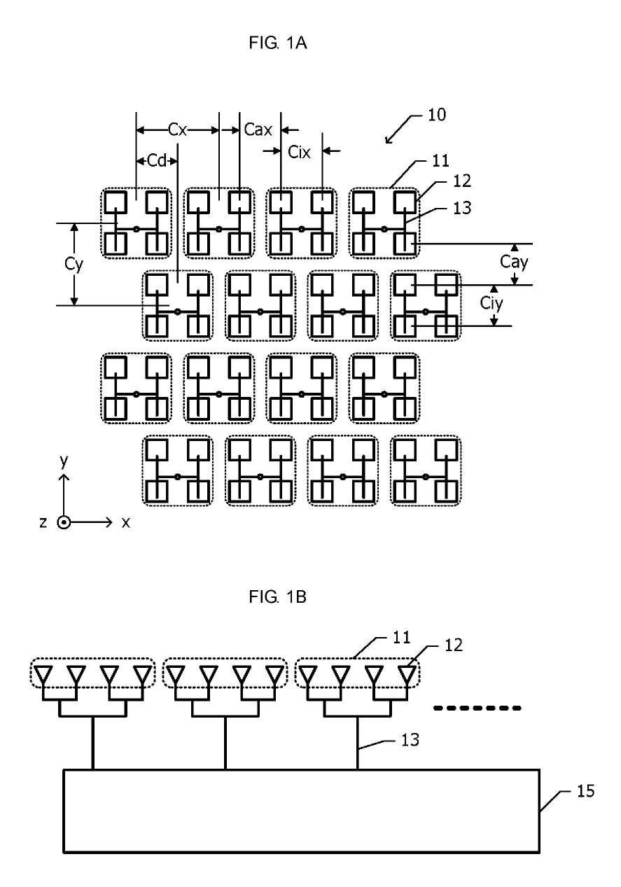

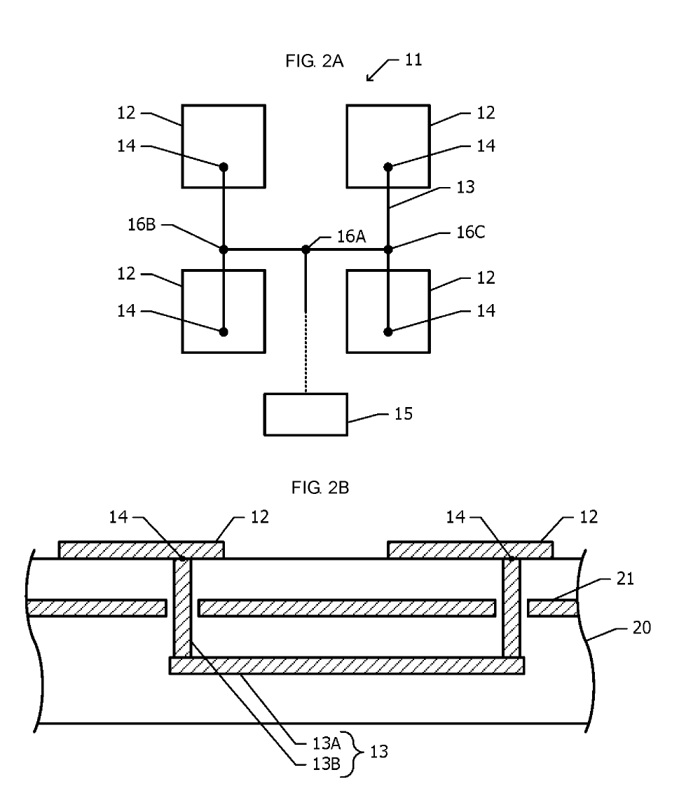

An array antenna according to a first embodiment will be described while referring to FIGS. 1A to 2B.

FIG. 1A is a plan view of an array antenna according to a first embodiment. An array antenna 10 according to the first embodiment includes a plurality of sub-arrays 11 that are two-dimensionally arranged in an x direction and a y direction, which are perpendicular to each other. For example, a total of sixteen, i.e., four in the x direction and four in the y direction, sub-arrays 11 are arranged. Each of the plurality of sub-arrays 11 includes four radiating elements 12 that are arranged in a two-row by two-column matrix in which the x direction is a row direction and the y direction is a column direction. Patch antennas are used as the radiating elements 12.

The arrangement of the radiating elements 12 inside the sub-arrays 11 is the same in the plurality of sub-arrays 11. A high-frequency signal is supplied to each radiating element 12 via power feeding lines 13 that branch from a power feeding line arranged in each sub-array 11. The four radiating elements 12 included in each one sub-array 11 are excited under conditions where excitation directions, excitation phases, and so on are identical.

The plurality of sub-arrays 11 are arranged at a regular pitch along straight lines in the x direction, and are arranged at a regular pitch in a zig-zag manner in the y direction. In other words, any two sub-arrays 11 that are adjacent to each other in the y direction are arranged so as to be shifted with respect to each other in the x direction. Cx represents the x direction pitch and Cy represents the y direction pitch of the plurality of sub-arrays 11, and Cd represents a shift amount in the x direction between two sub-arrays 11 that are adjacent to each other in the y direction. The shift amount Cd is ½ the x direction pitch Cx. The x direction pitch Cx and the y direction pitch Cy are the same.

When the x direction is defined as a row direction and the y direction is defined as a column direction, the sub-arrays 11 of the second row are arranged at positions that are shifted by Cd in the x direction with respect to the sub-arrays 11 of the first row. The sub-arrays 11 of the third row are arranged at the same positions as the sub-arrays 11 of the first row with respect to the x direction. The sub-arrays 11 of the fourth row are arranged at the same positions as the sub-arrays 11 of the second row with respect to the x direction. A plurality of images obtained by orthogonally projecting the plurality of sub-arrays 11 in straight lines parallel to the x direction are arranged at a pitch of Cx/2 in the x direction.

Cix represents the x direction pitch (distance between centers) and Ciy represents the y direction pitch of four radiating elements 12 inside one sub-array 11. Cax represents the shortest pitch in the x direction (the shortest distance between centers) between a radiating element 12 inside one sub-array 11 and a radiating element 12 inside another sub-array 11 among two sub-arrays 11 that are adjacent to each other in the x direction. Cay represents the shortest pitch in the y direction between a radiating element 12 inside one sub-array 11 and a radiating element 12 inside another sub-array 11 among two sub-arrays 11 that are adjacent to each other in the y direction.

The x direction pitch Cix inside a sub-array 11 (hereafter, referred to as “sub-array internal pitch”) and the x direction pitch Cax between sub-arrays 11 (hereafter, referred to as “sub-array pitch”) are the same. In other words, the radiating elements 12 are arranged at a regular pitch in the x direction. The y-direction sub-array internal pitch Ciy inside the sub-arrays 11 and the y-direction sub-array pitch Cay are also the same. In other words, the radiating elements 12 are arranged at a regular pitch in the y direction.

FIG. 1B is a diagram illustrating a connection state between the array antenna 10 according to the first embodiment and a high-frequency input/output device 15. The plurality of sub-arrays 11 are respectively connected to a plurality of input/output terminals of the high-frequency input/output device 15 via a plurality of power feeding lines 13. Each power feeding line 13, which is connected to an input/output terminal of the high-frequency input/output device 15, branches into two branches two times and is connected to the four radiating elements 12 inside one sub-array 11. Power is individually fed from the high-frequency input/output device 15 to each of the plurality of sub-arrays 11 via the plurality of power feeding lines 13.

FIG. 2A is a plan view illustrating one sub-array 11 and a part of a power feeding line 13. The power feeding line 13, which is connected to an input/output terminal of the high-frequency input/output device 15, branches into two branches at a branching point 16A, and then further branches into two branches at each of branching points 16B and 16C, and is thus connected to the four radiating elements 12. The radiating elements 12 each have a substantially rectangular or square shape in a plan view. A power feeding point 14 is provided in all of the radiating elements 12 at a position that is shifted by the same distance in the y direction from a position at the center of the radiating element 12. In other words, a plurality of plane figures, which are each composed of a radiating element 12 and a power feeding point 14, have translational symmetry with respect to each other. The line lengths from the first branching point 16A to the four power feeding points 14 are identical. Therefore, all of the radiating elements 12 inside one sub-array 11 are excited in the same direction and with the same phase.

FIG. 2B is a sectional view of a part of the array antenna 10 according to the first embodiment. A plurality of radiating elements 12 are formed on the upper surface of a dielectric substrate 20. A ground plane 21 is arranged in an inner layer of the dielectric substrate 20. The power feeding lines 13 are connected to the respective power feeding points 14 of the radiating elements 12. The power feeding lines 13 include microstrip lines 13A, which are arranged in an inner layer of the dielectric substrate 20, and via conductors 13B, which realize interlayer connections.

Next, advantageous effects of the first embodiment will be described. In the first embodiment, one input/output terminal of the high-frequency input/output device 15 is connected to one sub-array 11 and each sub-array 11 includes four radiating elements 12, and therefore a number of radiating elements 12 that is greater than or equal to the number of input/output terminals of the high-frequency input/output device 15 can be excited. Since the number of radiating elements 12 can be increased, a high antenna gain can be obtained. In other words, even though the number of radiating elements 12 is increased, an increase in the number of input/output terminals of the high-frequency input/output device 15 can be suppressed.

The plurality of sub-arrays 11 are respectively connected to the individual input/output terminals of the high-frequency input/output device 15, and therefore the phase of a high-frequency signal can be independently controlled in each sub-array 11. Consequently, beam steering can be performed in two directions, namely, the x direction and the y direction

Furthermore, in the first embodiment, in the array antenna 10 as a whole, the effective pitch in the x direction of the plurality of sub-arrays 11 is ½ the pitch Cx of the sub-arrays 11 in each row. Since the effective pitch with respect to the x direction is shorter, the beam swing angle with respect to the x direction can be made larger. In other words, compared with an array antenna in which the shift amount Cd (FIG. 1A) is zero, a reduction in gain in a specific direction in which the swing angle in the x direction is large can be suppressed. The array antenna operates as an array antenna in which the sub-arrays 11 are arranged at the pitch Cy with respect to the y direction.

For example, if the x direction is taken to be an azimuth direction and the y direction is taken to be an elevation direction, the swing angle of the beam in the azimuth direction can be made large. As a result, the coverage in the horizontal directions can be made large.

Next, modifications of the first embodiment will be described. In the first embodiment, the x direction sub-array internal pitch Cix (FIG. 1A) and the x direction sub-array pitch Cax (FIG. 1A) are identical, but these pitches do not necessarily have to be identical. For example, if the sub-array internal pitch Cix is made larger, the directivity of each sub-array 11 with respect to the x direction can be made sharper. If the sub-array pitch Cax is made smaller, the beam swing angle in the x direction can be made larger. The sub-array internal pitch Ciy and the sub-array pitch Cay may also similarly be made different with respect to the y direction.

In addition, in the first embodiment, a plurality of sub-arrays 11 are arranged at a regular pitch inside one row of the array antenna 10, but the plurality of sub-arrays 11 may instead be arranged at a non-regular pitch. In addition, a plurality of sub-arrays 11 may be arranged at a non-regular pitch in the y direction as well.

In the first embodiment, patch antennas are used as the radiating elements 12 (FIG. 1A), but another type of antenna such as slot antennas or dipole antennas may be used instead.

### Second Embodiment

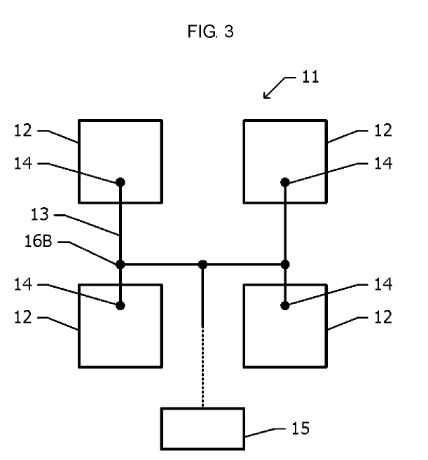

Next, an array antenna 10 according to a second embodiment will be described while referring to FIG. 3. Hereafter, the description of the parts of the configuration that are identical to those of the array antenna 10 according to the first embodiment illustrated in FIGS. 1A to 2B is omitted.

FIG. 3 is a plan view illustrating one sub-array 11 and a part of a power feeding line 13 of the array antenna 10 according to the second embodiment. In the first embodiment, the power feeding points 14 are arranged at positions that are shifted in the same direction from the centers of the radiating elements 12 in all of the radiating elements 12 (FIG. 2A) inside one sub-array 11. In the second embodiment, in any two radiating elements 12 that are adjacent to each other in the y direction, the power feeding points 14 are arranged at positions that are shifted by the same distance in directions such that the power feeding points 14 move closer to each other from the centers of the radiating elements 12. In other words, planar figures composed of two radiating elements 12 and two power feeding points 14 that are adjacent to each other in the y direction have mirror symmetry with each other.

A line length from a branching point 16B of the power feeding line 13 to the power feeding point 14 of one radiating element 12 and the line length from the branching point 16B of the power feeding line 13 to the power feeding point 14 of the other radiating element 12 are different from each other. This difference in line length is set such that the phases of the high-frequency signals fed to the two power feeding points 14 are shifted by 180° with respect to each other. As a result, the two radiating elements 12, which are adjacent to each other in the y direction, are excited in the same direction with the same phase.

Even through the power feeding points 14 are arranged in this way in the second embodiment, the same effects as in the first embodiment can be obtained by making the line lengths of the power feeding lines 13 different from each other and exciting the plurality of radiating elements 12 with the same phase.

### Third Embodiment

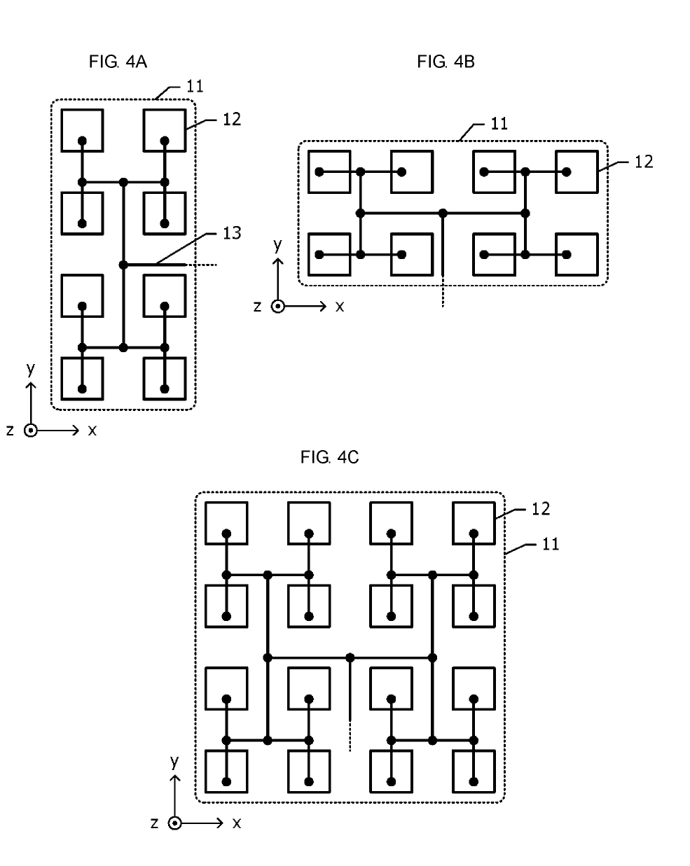

Next, an array antenna 10 according to a third embodiment will be described while referring to FIGS. 4A to 4C. Hereafter, the description of the parts of the configuration that are identical to those of the array antenna 10 according to the first embodiment illustrated in FIGS. 1A to 2B is omitted.

FIG. 4A is a plan view of one sub-array 11 of the array antenna 10 according to the third embodiment. In the first embodiment, one sub-array 11 includes four radiating elements 12 (FIG. 1A), whereas in the third embodiment, one sub-array 11 includes eight radiating elements 12. The eight radiating elements 12 are arranged in a four-row by two-column matrix. The power feeding line 13, which is connected to the high-frequency input/output device 15, extends to each of the plurality of radiating elements 12 via three branching points.

As illustrated in FIG. 4A, the directivity with respect to the y direction can be made sharper by arranging a greater number of radiating elements 12 in the y direction inside the sub-array 11.

As illustrated in FIG. 4B, eight radiating elements 12 may be arranged in a two-row by four-column matrix. Thus, the directivity with respect to the x direction can be made sharper by arranging a greater number of radiating elements 12 in the x direction.

As illustrated in FIG. 4C, sixteen radiating elements 12 may be arranged in a four-row by four-column matrix. The antenna gain can be increased by increasing the number of radiating elements 12.

The number of radiating elements 12 inside one sub-array 11 may be 2ⁿ. Here, n is a positive integer. In this case, the number of branching points in the power feeding line 13 that extends from the high-frequency input/output device 15 up to each radiating element 12 is equal to n. Thus, the number of branching points from the high-frequency input/output device 15 up to the radiating element 12 can be made identical for all the radiating elements 12.

### Fourth Embodiment

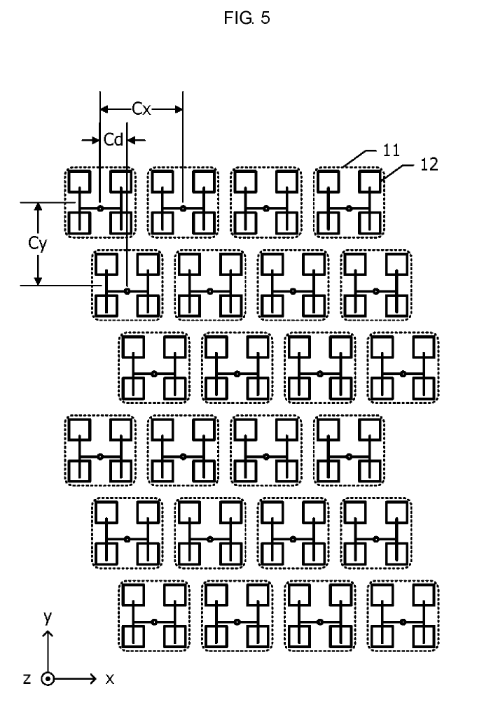

Next, an array antenna 10 according to a fourth embodiment will be described while referring to FIG. 5. Hereafter, the description of the parts of the configuration that are identical to those of the array antenna 10 according to the first embodiment illustrated in FIGS. 1A to 2B is omitted.

FIG. 5 is a plan view of the array antenna 10 according to the fourth embodiment. In the first embodiment, the shift amount Cd (FIG. 1A) in the x direction between two sub-arrays 11 that are adjacent to each other in the y direction is ½ the pitch Cx (FIG. 1A) of the sub-arrays 11 in each row. In the fourth embodiment, the shift amount Cd in the x direction between two sub-arrays 11 that are adjacent to each other in the y direction is ⅓ the pitch Cx of the sub-arrays 11 in each row. For example, the shift amount Cd of the sub-arrays 11 of the second row in the x direction with respect to the sub-arrays 11 of the first row and the shift amount Cd of the sub-arrays 11 of the third row in the x direction with respect to the sub-arrays 11 of the second row are ⅓ of the pitch Cx. The sub-arrays 11 of the fourth row are arranged at the same positions as the sub-arrays 11 of the first row with respect to the x direction.

A plurality of images obtained by orthogonally projecting the plurality of sub-arrays 11 in straight lines parallel to the x direction are arranged at a pitch of Cx/3 in the x direction. The x direction effective pitch of the plurality of sub-arrays 11 is smaller in the fourth embodiment than in the first embodiment, and therefore the swing angle of the beam in the x direction can be made larger.

The shift amount Cd may be ¼ the x direction pitch Cx. More generally, the shift amount Cd may be 1/m the x direction pitch Cx. Here, m is an integer greater than or equal to 2. The swing angle of the beam in the x direction can be made larger by making the shift amount Cd smaller.

Each of the above-described embodiments is an illustrative example and it goes without saying that parts of the configurations illustrated in different embodiments can be substituted for one another or combined with one another. The same operational effects resulting from the same configurations in a plurality of embodiments are not repeatedly described in the individual embodiments. In addition, the present disclosure is not limited to the above-described embodiments. For example, it will be obvious to a person skilled in the art that various changes, improvements and combinations are possible.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An array antenna comprising:
a plurality of sub-arrays each including a plurality of radiating elements arranged two-dimensionally in a first direction and a second direction, wherein the first direction and the second direction are perpendicular to each other; and
a plurality of power feeding lines individually feeding power from a high-frequency input/output device to the plurality of sub-arrays;
wherein the plurality of sub-arrays are arranged along straight lines in the first direction, and are arranged in the second direction such that among two sub-arrays adjacent to each other in the second direction, one sub-array is shifted in the first direction with respect to the other sub-array.

2. The array antenna according to claim 1,
wherein the plurality of sub-arrays are arranged at a first pitch in the first direction, and a shift amount with respect to the first direction between positions of two sub-arrays adjacent to each other in the second direction is less than or equal to ½ the first pitch.

3. The array antenna according to claim 2,
wherein a plurality of images obtained by orthogonally projecting the plurality of sub-arrays in straight lines parallel to the first direction are arranged at a regular pitch less than or equal to ½ the first pitch in the first direction.

4. The array antenna according to claim 1,
wherein the plurality of sub-arrays arranged in the second direction are arranged in a zig-zag pattern.

5. The array antenna according to claim 1,
wherein the plurality of sub-arrays are arranged at a second pitch in the second direction.

6. The array antenna according to claim 1,
wherein the plurality of sub-arrays each consist of 2ⁿ of the radiating elements, where n is a positive integer.

7. The array antenna according to claim 2,
wherein the plurality of sub-arrays arranged in the second direction are arranged in a zig-zag pattern.

8. The array antenna according to claim 3,
wherein the plurality of sub-arrays arranged in the second direction are arranged in a zig-zag pattern.

9. The array antenna according to claim 2,
wherein the plurality of sub-arrays are arranged at a second pitch in the second direction.

10. The array antenna according to claim 3,
wherein the plurality of sub-arrays are arranged at a second pitch in the second direction.

11. The array antenna according to claim 4,
wherein the plurality of sub-arrays are arranged at a second pitch in the second direction.

12. The array antenna according to claim 2,
wherein the plurality of sub-arrays each consist of 2ⁿ of the radiating elements, where n is a positive integer.

13. The array antenna according to claim 3,
wherein the plurality of sub-arrays each consist of 2ⁿ of the radiating elements, where n is a positive integer.

14. The array antenna according to claim 4,
wherein the plurality of sub-arrays each consist of 2ⁿ of the radiating elements, where n is a positive integer.

15. The array antenna according to claim 5,
wherein the plurality of sub-arrays each consist of 2ⁿ of the radiating elements, where n is a positive integer.
